(19) United States
(12) Patent Application Publication
(10) Pub. No.: US 2007/0289157 A1
(43) Pub. Date: Dec. 20, 2007

(54) Dryer for medical Capsule

(75) Inventor: Ju Su KIM, Seoul (KR)

Correspondence Address: Jefferson IP Law, LLP, 1730 M STREET, NW, SUITE 807, WASHINGTON, DC, 20036, US

(73) Assignee: CHANG SUNG PHARMATECH CO., LTD, Pocheon-city (KR)

(21) Appl. No.: 11/762,883

(22) Filed: Jun. 14, 2007

(30) Foreign Application Priority Data
Jun. 15, 2006 (KR) 20-2006-0016062
Jun. 7, 2007 (KR) 20-2007-0009355

(51) Int. Cl. F26B 25/06

(52) U.S. Cl. 34/201; 34/202

(57) ABSTRACT

Disclosed is a dryer for a medical capsule. The dryer has a body including a rectangular frame and a dry box installed in the body. A gear wheel installed in the body and a gear array is formed in the dry box to engage with the gear wheel. Guide rollers are rotatably installed at both sides of an upper portion of the gear wheel, and a cover is provided to cover the dry box, which is accommodated in the body while partially protruding upward out of the body. A front plate is provided to open/close a front portion of the rectangular frame of the body, and a support plate is provided at a rear portion of the front plate in line with the guide rollers to support the dry box coming out of the body.

### BACKGROUND OF THE INVENTION

1. Field of the Invention

The present invention relates to a dryer for a medical capsule used as a medical supply. More particularly, the present invention relates to a dryer for a medical capsule, in which a dry box is easily disassembled from the dryer after the medical capsule has been dried in the dry box, so that the user can readily wash the dry box and impurities can be easily removed during the drying process.

2. Description of the Related Art

A conventional dryer includes a body, in which a dry box is rotatably installed while partially protruding from the body, and a cover that covers the body in such a manner that impurities can be prevented from being introduced into the body and the user can check the impurities existing in the body. The cover is prepared in the form of a cabin and is made from a transparent material, so the user can visually inspect the rotational state of the dry box even if the dry box, which is accommodated in the body while partially protruding from the body, is covered with the cover.

In addition, once the cover is put on the body to close the body, the cover is not easily separated from the body. Thus, when it is necessary to take out the dry box from the body to wash the dry box, at least two workers must open the cover to take out the dry box. The same procedure is also necessary when putting the dry box into the body after washing the dry box, causing great time loss and waste of labor force.

Applicant of the present invention has filed Utility Model Application, entitled “dryer for medical capsule”, in the Korean Intellectual Property Office. According to the above Application, a cover is hinged to a body by means of a hinge device and a shock absorber is installed between the cover and the body to maintain the cover in the opened state relative to the body, so that the worker can frequently inspect a dry box by opening the cover when the fault occurs during the drying process for the medical capsule. However, although the above dryer is useful in that the user can frequently inspect the state of the dry box and simply remove impurities, at least two workers are necessary to take out the dry box from the body to wash the dry box, so waste of labor force may occur.

### SUMMARY OF THE INVENTION

The present invention has been made to solve the above problems occurring in the prior art, and an object of the present invention is to provide a dryer for a medical capsule, wherein a front surface of a body in which a dry box is installed is opened/closed such that the dry box can come out of the body through the front surface of the body, a support section is formed to primarily fix the dry box when the dry box has come out of the body, a guide plate is provided to allow the dry box to completely come out of the dry box, and a carrier is provided to move the dry box that has come out of the body, so that the washing operation for the dry box can be performed by a worker alone.

In addition, the cover is hinged to the body by means of a hinge device and is rotatably coupled to the body by means of a shock absorber, so that the worker alone can open/close the cover and can take out the dry box from the body.

### BRIEF DESCRIPTION OF THE DRAWINGS

The above and other advantages of the present invention will become readily apparent with reference to the following detailed description when considered in conjunction with the accompanying drawings wherein:

FIG. 1 is a perspective view illustrating the disassembling process for a dry box according to the present invention;

FIG. 2 is a perspective view illustrating the opening/closing state of a body according to the present invention;

FIG. 3 is a perspective view illustrating the opening state of a cover according to the present invention;

FIG. 4 is an assembled view of a dryer according to the present invention;

FIG. 5 is an enlarged perspective view illustrating the mounting state of a support plate and a guide plate according to the present invention;

FIG. 6 is an enlarged perspective view illustrating the inclined surface of the guide plate according to the present invention;

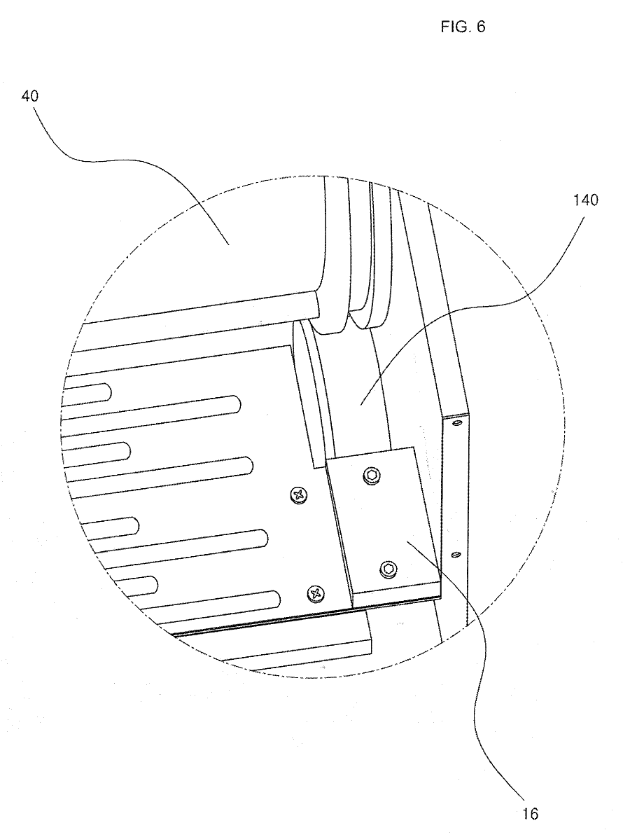

FIG. 7 is a view illustrating a driving wheel and a guide roller installed in a body according to the present invention;

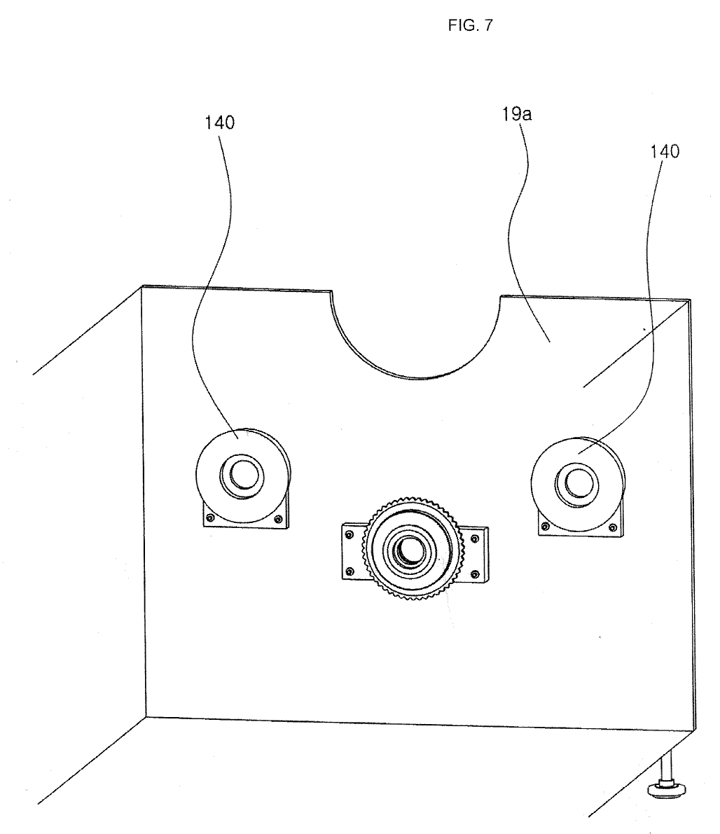

FIG. 8 is a perspective view illustrating the closing state of the dryer in a state in which a front plate has been closed;

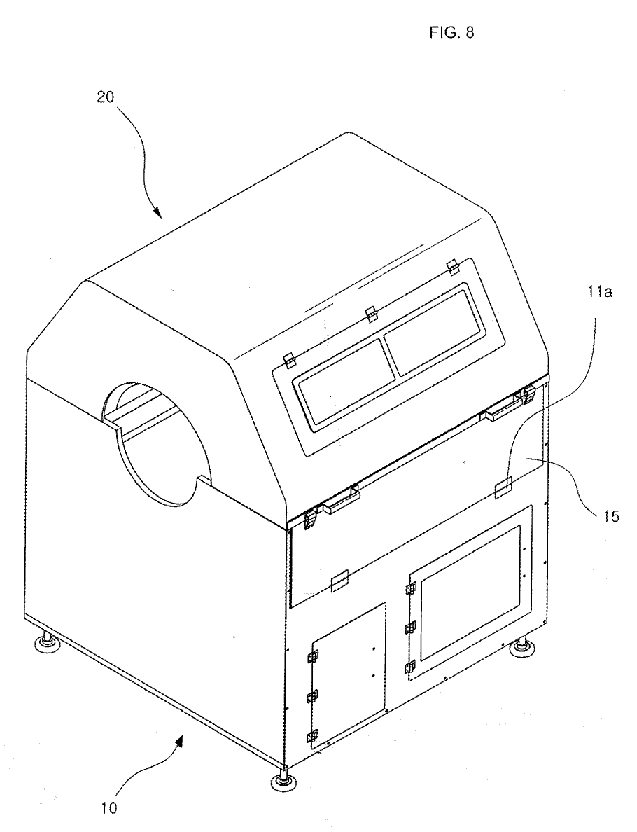

FIG. 9 is a perspective view illustrating the external structure of a carrier according to the present invention;

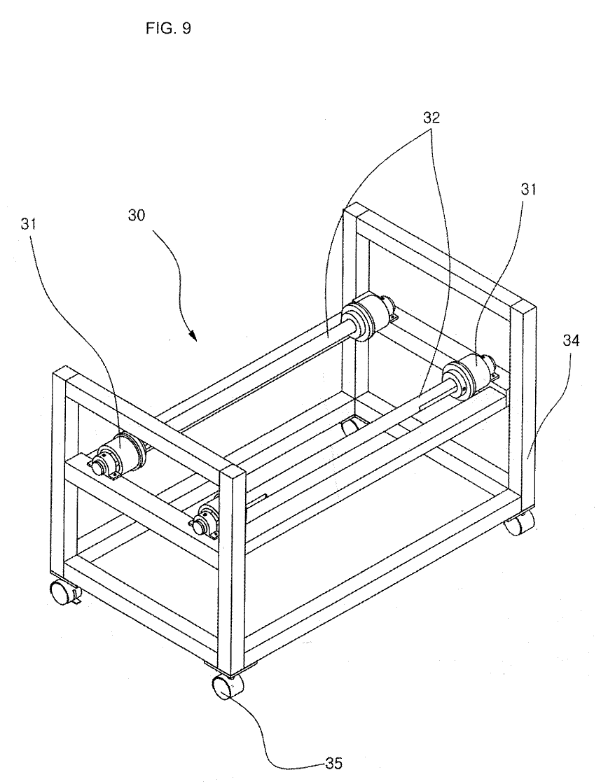

FIG. 10 is a perspective view illustrating a support roller installed in a carrier according the present invention; and

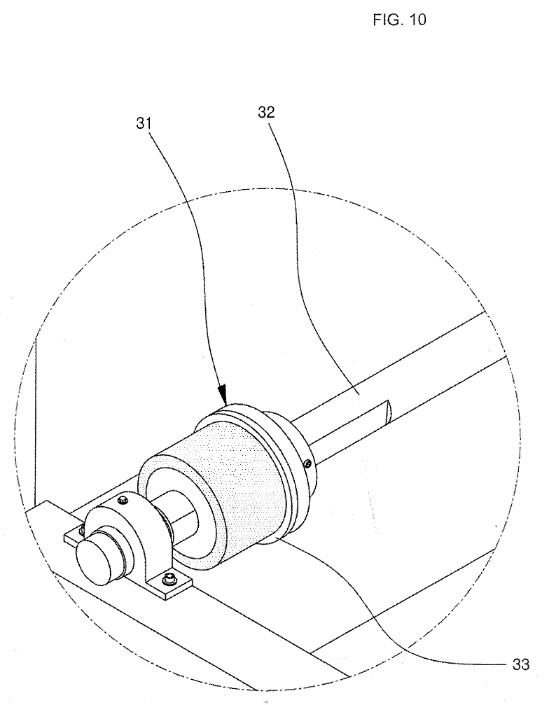

FIG. 11 is a perspective view illustrating the usage state of a dryer having a dry box therein according to the present invention.

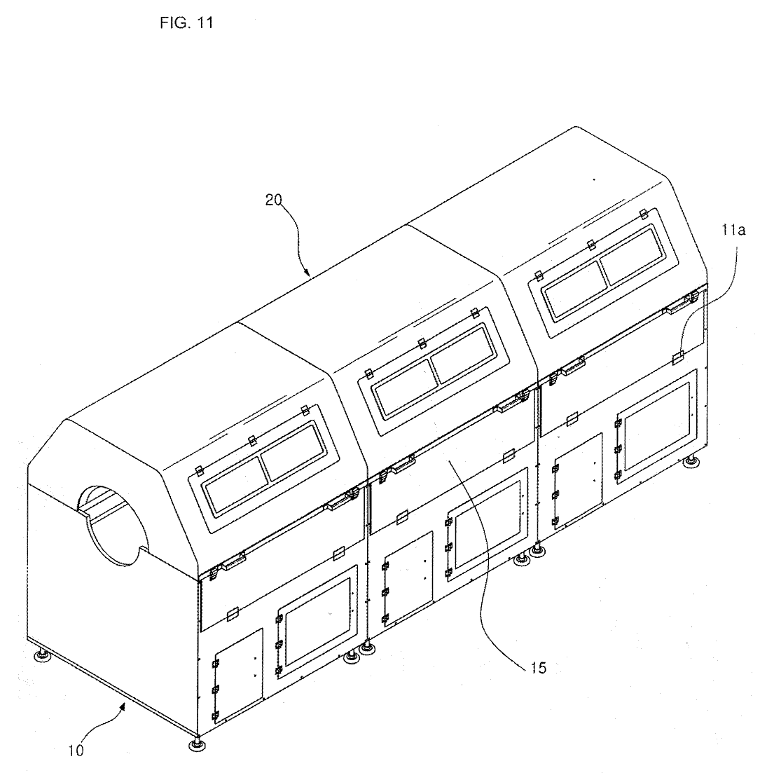

### DESCRIPTION OF THE EMBODIMENTS

Hereinafter, exemplary embodiments of the present invention will be explained in detail with reference to the accompanying drawings.

A dryer according to the present invention includes a body 10 and a dry box 40 installed in the body 10. A gear wheel 120 is rotatably installed in the body 10 to transfer the driving force of a motor 100 to the dry box 40 through a belt 110, and a gear array 41 engaged with the gear wheel 120 is provided in the dry box 40. In order to guide the rotation of the dry box 40, guide rollers 130 are installed at both sides of an upper portion of the gear wheel 120. The guide rollers 130 are provided at both left and right sides of the dry box 40, so that the dry box 40 can be rotated in the forward direction.

In addition, the body 10 having the dry box 40 therein includes a rectangular frame 19. An upper surface of the rectangular frame 19 is opened in such a manner that at least a half of the dry box 40 accommodated in the body 10 protrudes upward out of the body 10. In this case, the dry box 40 can be easily installed in and removed from the body 10. A cover 20 is provided on the body 10 and is coupled with the rectangular frame 19. The cover 20 is prepared in the form of a cabin, so the cover 20 can receive a predetermined portion of the dry box 40 that protrudes upward out of the body 10.

The dry box 40 installed in the body 10 has a mesh structure to allow air to pass therethrough. A blower 140 is provided in the body 10 in order to feed air into the dry box 40 to dry the medical capsule provided in the dry box 40. At this time, the dry box 40 is rotated by means of the motor 100 to improve the drying efficiency for the medical capsule.

In addition, a support plate 16 is provided in front of the guide rollers 130 in line with the guide rollers 130 to open/close the front portion of the rectangular frame 19 of the body 10. Further, guide plates 17 are provided at both inner sidewalls of the rectangular frame 19 in the vicinity of the guide rollers 130 in order to guide the dry box 40 coming out of the body 10.

The support plate 16 is inclined upward in the discharge direction of the dry box 40, so the dry box 40 may not be separated from the body 10 if external force is not applied thereto.

In addition, an inclined surface 17a is formed at the front portion of the guide plate 17, so that the dry box 40 can easily return to its initial position in the body 10 while being guided by the inclined surface 17a.

Since the cover 20 must be opened when assembling or disassembling the dry box 40, the cover 20 is hinged to the rear portion of the body 10 by means of a hinge device 11, and a shock absorber 12 is installed between the body 10 and the cover 20 to facilitate the opening/closing operation of the cover 20 and to support the cover 20 being opened/closed relative to the body 10.

In addition, locking devices 18 are provided at both lateral sides of a front plate 15 to open/close the front portion of the rectangular frame 19.

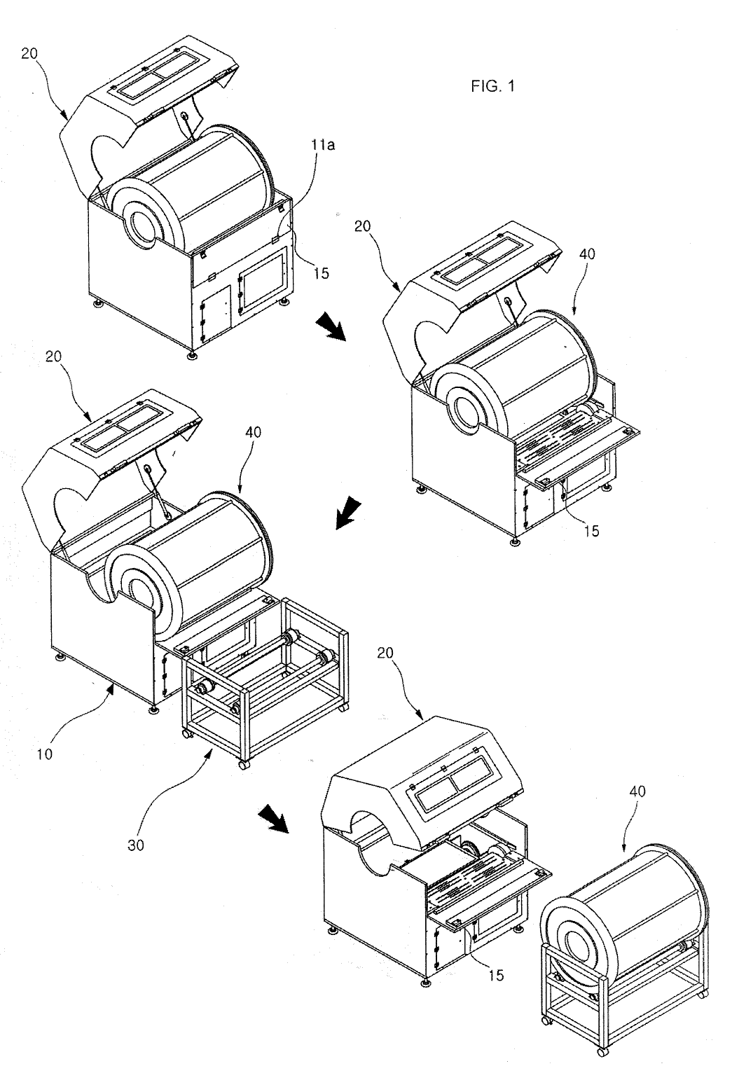

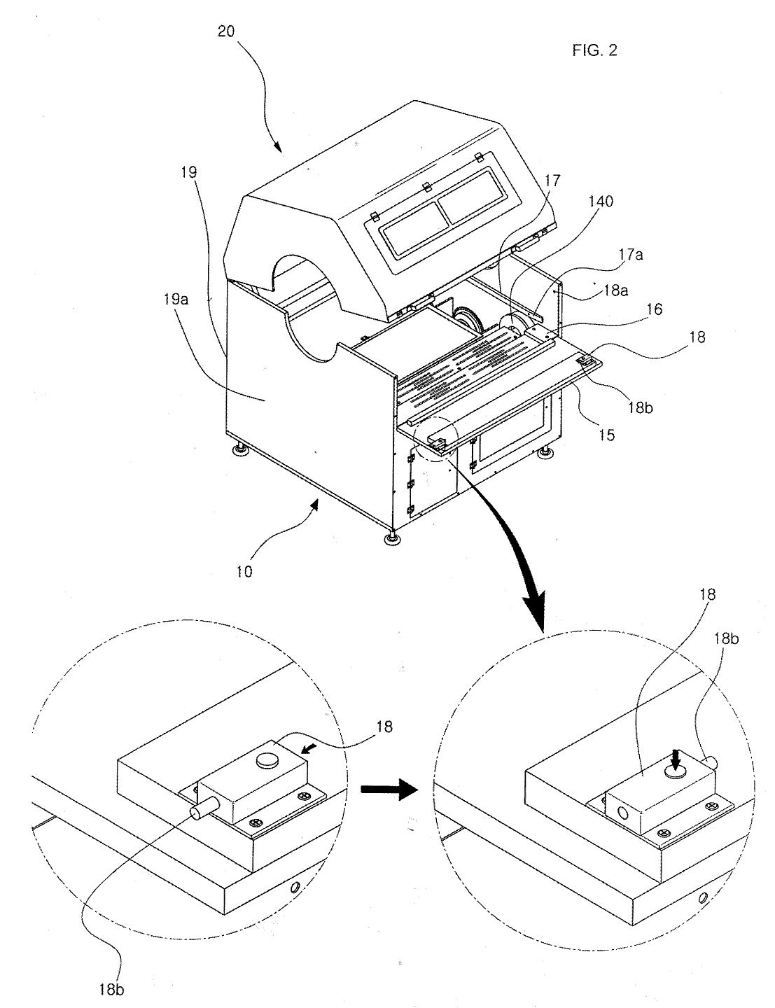

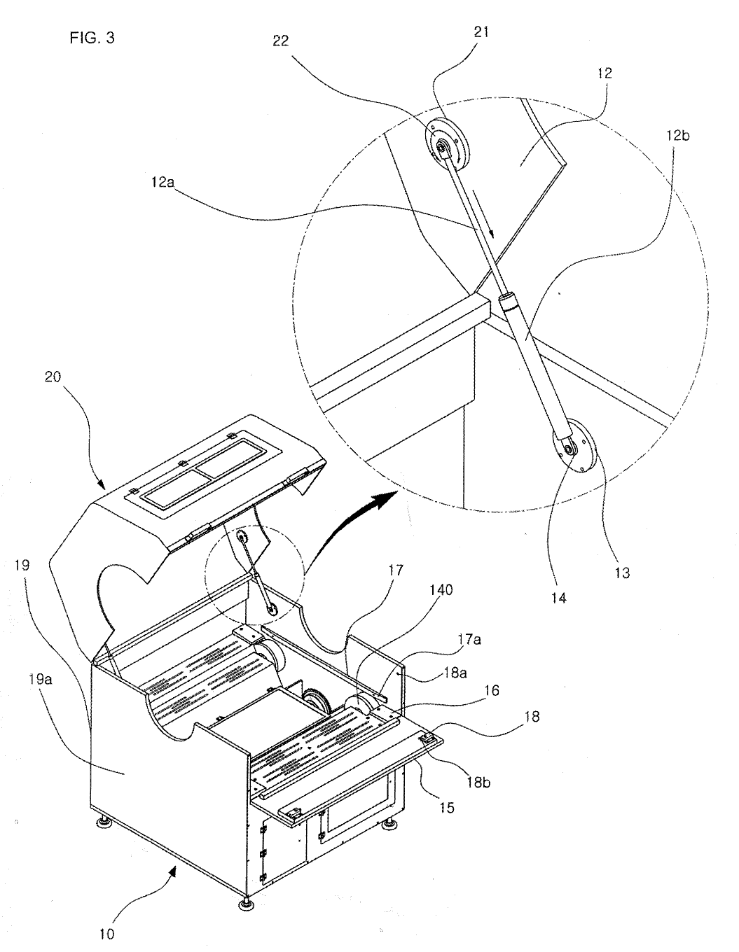

FIG. 1 is a perspective view illustrating the disassembling process for the dry box, FIG. 2 is a perspective view illustrating the opening/closing state of the front plate relative to the rectangular frame, and FIG. 3 is a perspective view illustrating the opening state of the cover in a state in which the front plate has been opened.

As shown in FIGS. 1 to 3, the dryer according to the present invention includes the body 10 having the rectangular frame 19. The front plate 15 is hinged to the front portion of the rectangular frame 19 by means of a hinge 11a. The front plate 15 is opened/closed relative to the rectangular frame 19 of the body 10 by means of the locking devices 19. To this end, locking holes 18a are formed at both sidewalls 19a of the rectangular frame 19 such that locking pins 18b of the locking devices 18 can be inserted into the locking holes 18a.

In addition, the cover 20 is pivotably coupled to the body 10 by means of the hinge device 11, so that the cover 20 is opened/closed relative to the body 10. At this time, the shock absorber 12 installed between the body 10 and the cover 20 facilitates the opening/closing operation of the cover 20. The shock absorber 12 is mounted by means of brackets 13 and 21 having rotating sections 14 and 22, respectively. The brackets 13 and 21 allow the shock absorber 12 to be precisely operated when the cover 20 is being opened and closed.

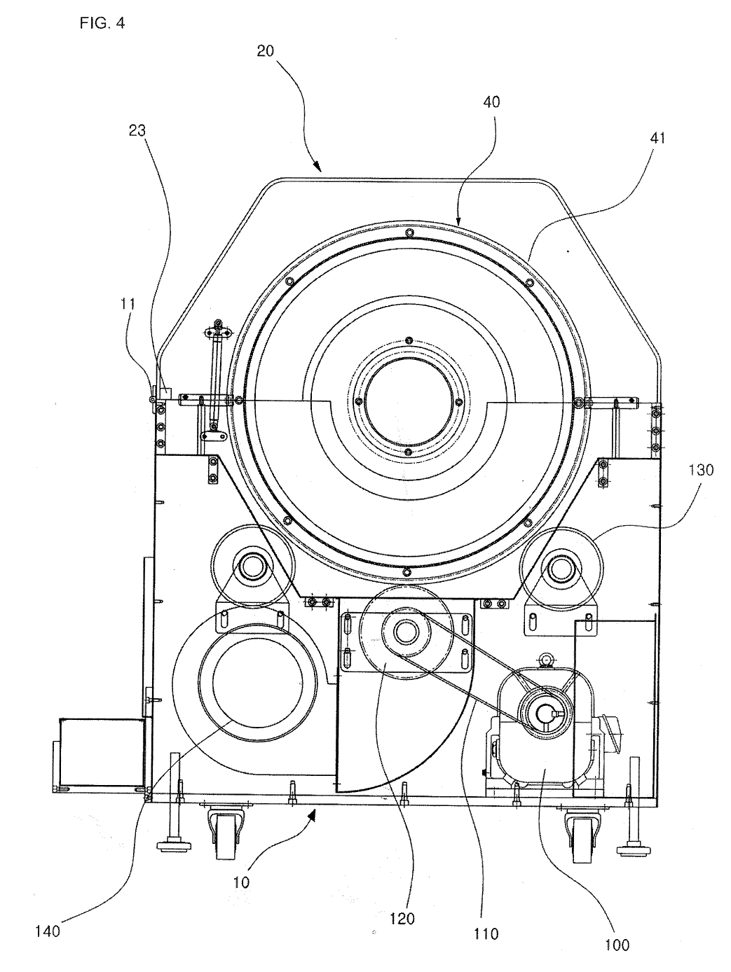

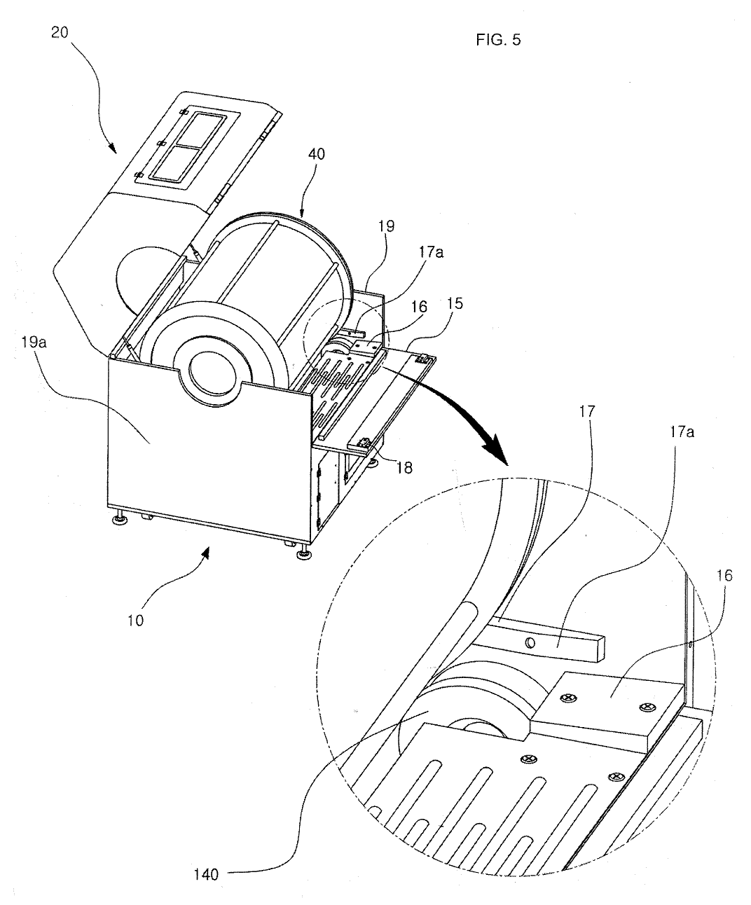

FIGS. 4 and 5 show the structure of the dryer capable of preventing the dry box 40 from being damaged when the dry box 40 comes out of the body 10. In a state in which the front plate 15 is opened and the dry box 40 is placed on the guide rollers 130, if worker pulls the dry box 40 in the front direction, the dry box 40 is transferred from the guide rollers 130 to the support plate 16. Since the support plate 16 is gradually inclined upward in the discharge direction of the dry box 40, the support plate 16 may primarily prevent the dry box 40 from falling down when the worker pulls the dry box 40.

In addition, when the dry box 40 comes out of the body 10 through the front surface of the body 10 caused by the pulling operation of the worker, the dry box 40 may be inclined in one direction if the pulling operation is erroneously conducted. To solve this problem, the guide plates 17 are provided at inner sidewalls of the body 10 in the vicinity of the guide rollers 130.

Each guide plate 17 is formed at the front portion thereof with the inclined surface 17a, so the dry box 40 can easily return to its initial position in the body 10 after it has been washed.

In addition, as shown in FIG. 3, when the cover 20 is closed relative to the body 10, the shock absorber 12 installed between the body 10 and the cover 20 is maintained in the upright state. In contrast, when the cover 20 is opened relative to the body 10, the shock absorber 12 is inclined between the body 10 and the cover 20.

In order to prevent the cover 20 from being vibrated when the cover 20 is opened/closed relative to the body 10 about the hinge device 11, a reinforcement bar 23 is provided in the cover 20. Due to the reinforcement bar 23, the hinge device 11 can be securely fixed and the hinge operation is stably performed.

A worker alone can move the dry box 40 that comes out of the body 10 to the place for washing by using a carrier 30. The carrier 30 includes a frame 34 and wheels 35 installed at the bottom of the frame 34 to move the carrier 30 in various directions. Two shafts 32 are provided in the frame 34 and support rollers 31 are installed at both end portions of the shafts 32. Preferably, the distance between two shafts 32 is determined such that the dry box 40 can be rotatably placed between the shafts 32.

The support roller 31 is coupled to the bracket 31 a fixed to the shaft 32 and a stopper ring 33 is provided in the support roller 31 to prevent the dry box 40 from being separated from the support roller 31.

The support roller 31 is made from elastic or flexible material to prevent the dry box 40 from being damaged. According to the present invention, nylon or Teflon is used for the support roller 31 to protect the dry box 40 and to improve the durability of the dry box 40.

When it is necessary to disassemble the dry box 40 from the body 10, the worker opens the cover 20 and the front plate 15 after turning off the motor 100. In this state, if the worker pulls the dry box 40 in the front direction, the dry box 40 is smoothly transferred from the guide rollers 130 to the support plate 16. Since the support plate 15 is inclined upward, the dry box 40 can be stably maintained on the support plate 15 without falling down to the ground. In this state, the carrier 30 is positioned below the dry box 40 and the worker again pulls the dry box 40 in the front direction, so that the dry box 40 is transferred from the dryer to the carrier 30. The dry box 40 mounted on the carrier 30 is transferred to the place for washing. If the washing process for the dry box 40 has been finished, the carrier 30 is moved to the front portion of the dryer. In this state, if the worker pushes the dry box 40, the dry box 40 is placed on the support plate 16. Then, the dry box 40 is rested on the guide rollers 130 while being guided by the inclined surface 17a of the guide plate 17. At this time, the gear array 41 of the dry box 40 engages with the gear wheel 120.

Then, the motor 100 is operated, so that the gear array 41 of the dry box 40, which engages with the gear wheel 120 rotated by means of the motor 100, is rotated. Accordingly, the dry box 40 is also rotated in its original position.

Meanwhile, in a state in which the front plate 15 has been closed, the locking pin 18b of the locking device 18 is inserted into the locking hole 18a, so that the front plate 15 can be fixedly locked.

In addition, when the worker opens the cover 20 relative to the body 10, the rotating sections 14 and 22 of the brackets 13 and 21 rotate so that the shock absorber 12 is slantingly aligned between the cover 20 and the body 10. Thus, the cover 20 that is opened relative to the body 10 is supported by the shock absorber 12 without moving down to the body 10 due to the tare thereof, so that the worker alone can simply open/close the cover 20.

At this time, the rotating sections 14 and 22 of the brackets 13 and 21 used for fixing the shock absorber 12 protrude outward beyond the brackets 13 and 21 to prevent a cylinder 12b of the shock absorber 12 from interfering with the body and the inner wall of the cover 20.

Therefore, if external force is not applied to the cover 20 opened relative to the body 10, the cover 20 is not closed due to the damping action of the shock absorber 12, so the worker can simply open/close the cover 20. The worker may close the cover 20 by applying force to the cover 20. In this case, the cover 20 can be smoothly closed by means of the shock absorber 12.

As described above, according to the present invention, the front plate is provided at the front portion of the rectangular frame constituting the body, so that the dry box can be easily disassembled from the body. In addition, the support plate is provided to hold the dry box coming out of the body. In order to facilitate the assembling/disassembling operation of the dry box, the guide plates are provided at the sidewalls of the rectangular frame in the vicinity of the guide rollers. In addition, the cover can be smoothly opened/closed by means of the shock absorber, so that the washing operation for the dry box can be performed by the worker alone.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A dryer for a medical capsule, the dryer comprising:
a body including a rectangular frame having a blowing device that feeds air to dry the medical capsule;
a dry box installed in the body;
a gear wheel installed in the body to transfer a driving force of a motor to the dry box through a belt;
a gear array formed in the dry box to engage with the gear wheel;
guide rollers rotatably installed at both sides of an upper portion of the gear wheel in order to guide rotation of the dry box;
a cover in a form of a cabin that covers the dry box, which is accommodated in the body while partially protruding upward out of the body;
a front plate for opening/closing a front portion of the rectangular frame of the body; and
a support plate provided at a rear portion of the front plate in line with the guide rollers, on which the dry box is rotatably mounted, in order to support the dry box coming out of the body.

2. The dryer as claimed in claim 1, wherein the cover is hinged to the body by means of a hinge device, and is opened/closed relative to the body while being supported by a shock absorber having a rotating section.

3. The dryer as claimed in claim 1, wherein guide plates are provided at inner sidewalls of the body adjacent to the guide rollers in order to guide the dry box coming out of the body through a front surface of the body.

4. The dryer as claimed in claim 1, wherein the support plate is inclined upward in a discharge direction of the dry box, so that the dry box is prevented from falling down to a ground if external force is not applied to the dry box.

5. The dryer as claimed in claim 3, wherein an inclined surface is formed at a front portion of the guide plate to guide the dry box being assembled into the body.

6. The dryer as claimed in claim 1, wherein a locking device is provided at a front portion of the rectangular frame such that the front portion of the rectangular frame is opened/closed by means of the locking device.

7. The dryer as claimed in claim 1, further comprising a carrier used for moving the dry box that has been disassembled from the body.

8. The dryer as claimed in claim 1 or 2, wherein the cover is pivotably opened or closed relative to the body about the hinge device, an opening/closing operation of the cover is controlled by means of the shock absorber, and the dry box that has been disassembled from the body through the front plate of the body is transferred to a place for washing by means of a carrier.

9. The dryer as claimed in claim 7, wherein the carrier comprises a frame, wheels installed at a bottom of the frame to move the carrier in various directions, two shafts installed in the frame, and support rollers installed at both ends of the two shafts, in which a distance between two shafts is determine such that the dry box is stably placed therebetween.

10. The dryer as claimed in claim 9, wherein the support rollers are coupled with brackets fixed to the shafts.
